(19) United States
(12) Patent Application Publication
(10) Pub. No.: US 2016/0265603 A1
(43) Pub. Date: Sep. 15, 2016

(54) ELECTROMECHANICAL, UNIDIRECTIONAL, ROTARY CLUTCH SYSTEMS AND METHODS

(71) Applicants: Gregory Sawicki, Raleigh, NC (US); Michael B. Wiggin, Raleigh, NC (US); NORTH CAROLINA STATE UNIVERSITY, Raleigh, NC (US)

(72) Inventors: Gregory Sawicki, Raleigh, NC (US); Michael B. Wiggin, Raleigh, NC (US)

(21) Appl. No.: 15/031,601

(22) PCT Filed: Oct. 22, 2014
(86) PCT No.: PCT/US2014/061668

§ 371 Date: Apr. 22, 2016

Related U.S. Application Data
(60) Provisional application No. 61/894,272, filed on Oct. 22, 2013.

(51) Int. Cl. F16D 41/12; F16D 27/14; F16D 27/102

(52) U.S. Cl. CPC F16D 41/12; F16D 27/102; F16D 27/14; F16D 41/30

(57) ABSTRACT

Electromechanical unidirectional rotary clutch systems and methods are disclosed. According to an aspect, a clutch system includes an input member having an axis of rotation. The system also includes an output member defining an interior surface that faces the axis. Further, the system includes multiple pawls attached to the input member and each being configured to be positioned in a first position to engage the interior surface of the output member, and to be positioned in a second position such that the pawls do not engage the interior surface of the output member. The system also includes an electromechanical control configured to move the pawls between the first and second positions for engaging and disengaging the interior surface of the input member.

### CROSS REFERENCE TO RELATED APPLICATION

This application claims the benefit of and priority to U.S. Provisional Patent Application No. 61/894,272, filed Oct. 22, 2013 and titled ELECTROMECHANICAL UNIDIRECTIONAL ROTARY CLUTCH SYSTEMS AND METHODS; the disclosure of which is incorporated herein by reference in its entirety.

### BACKGROUND

1. Technical Field

The present subject matter relates to clutch systems. More particularly, the present subject matter relates to electromechanical unidirectional rotary clutch systems and methods.

2. Description of Related Art

Many mechanical devices such as bicycle hubs and robotics use unidirectional clutches that allow unrestricted motion in one direction but either restrict or transmit motion if turned in the opposite direction. Such functions can be implemented by use of friction, magnetism, or interference. Clutches can be either passive, requiring no external signal or energy source to engage or disengage, or active, whereby an external signal or energy source engages/disengages the clutching mechanism. An active clutch can be implemented electromechanically, whereby a motor, magnet, or source of friction holds a substantial amount of force required to stop the clutch from freely spinning. These devices can be large, bulky, and require a substantial amount of energy. Further, these devices may not be capable of holding a substantial amount of force relative to their sizes. In view of these shortcomings and others, it is desired to provide improved clutches and related techniques.

### BRIEF SUMMARY

Disclosed herein are electromechanical, unidirectional, rotary clutch systems and methods. According to an aspect, a clutch system includes an input member having an axis of rotation. The system also includes an output member defining an interference surface. For example, the interference surface may be an interior surface (e.g., ratcheting mechanism) of the output member that faces the axis of rotation of the input member. Alternatively, for example, the interference surface may be an exterior surface of the input member. Further, the system includes multiple pawls attached to the input member. Each pawl can be configured to be positioned in a respective first position to engage the interference surface of the output member, and to be positioned in a respective second position such that the pawls do not engage the interference surface of the output member. The system also includes an electromechanical control configured to move the pawls between their respective first and second positions for alternately engaging and disengaging the interference surface of the input member.

### BRIEF DESCRIPTION OF THE SEVERAL VIEWS OF THE DRAWINGS

FIGS. 1A and 1B are front views of a unidirectional, rotary clutch system having an electromechanical control in different modes for alternately engaging and disengaging an output member in accordance with embodiments of the present subject matter;

FIG. 2 is a front view of additional details of the clutch system shown in FIGS. 1A and 1B;

FIGS. 3 and 4 are perspective views of the clutch system shown in FIG. 1 in different modes for disengaging and engaging, respectively, the output member in accordance with embodiments of the present subject matter;

FIG. 5 is a perspective, exploded view of the clutch system in accordance with embodiments of the present subject matter;

FIG. 6 is a sectioned view of the bracket and the bearing in accordance with embodiments of the present subject matter;

FIGS. 7A-7D depict different views of another example clutch system in accordance with embodiments of the present subject matter; and

FIG. 8 illustrates a side view of a clutch system attached to an exoskeleton for a person's leg in accordance with embodiments of the present subject matter

### DETAILED DESCRIPTION

As described herein, there are various embodiments and aspects of the present subject matter. Particularly, disclosed herein are electromechanical, unidirectional, rotary clutch systems and methods. In accordance with embodiments, clutches disclosed herein are configured such that all or a substantial amount of forces are held in passive components. A motor can be used for activating and de-activating a ratcheting mechanism. As a result, the clutch can actively transform from a freely rotating bearing to a unidirectional clutch with an electrical signal of low power. Further details and advantages are disclosed herein.

Disclosed herein are low power, electromechanical, unidirectional rotary clutch systems. An example use includes wearable robotics applications (e.g., exoskeletons, prostheses, etc.) using controlled energy storage and return in elastic materials (e.g., springs). IN an example, a small servo motor may be the only component requiring power for the engagement of a pawl onto a ratcheting mechanism as disclosed herein. A clutch as disclosed herein may allow for the transfer of energy from rotary motion of human joints (e.g., ankle) into and out of springs worn in parallel with the body with precise timing based on biological feedback signals (e.g., ground contact events, joint angle threshold, and/or muscle activity threshold). In an alternative to the servo motor, any other suitable mechanism or component may be used to drive engagement of output (i.e., ratchet) and input (i.e., pawl(s)) members, such as, but not limited to, another type of motor, a micro actuator, a stepper motor, a smart material that can deform under application of current, or the like. This may in turn allow for pseudo-passive devices that can offload biological muscles and joints in a framework that is highly adaptable over a wide range of gaits and speeds.

In accordance with embodiments, the presently disclosed clutch systems and techniques may be suitably applied as a safety mechanism or a way to offload forces from motors while statically holding loads. For example, could the presently disclosed systems and techniques may be added to a pulley on a crane or elevator to restrict downward motion and offload forces from the crane or elevator's main motor into static members.

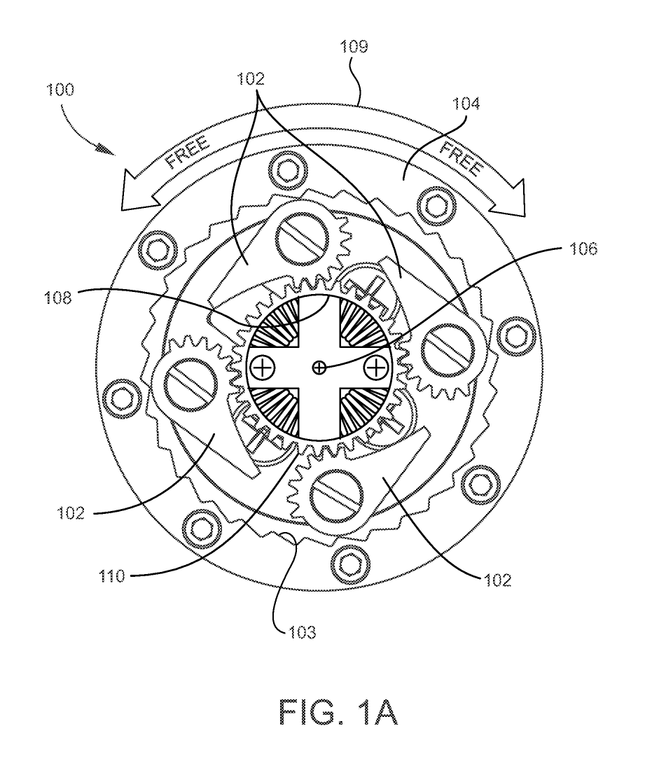

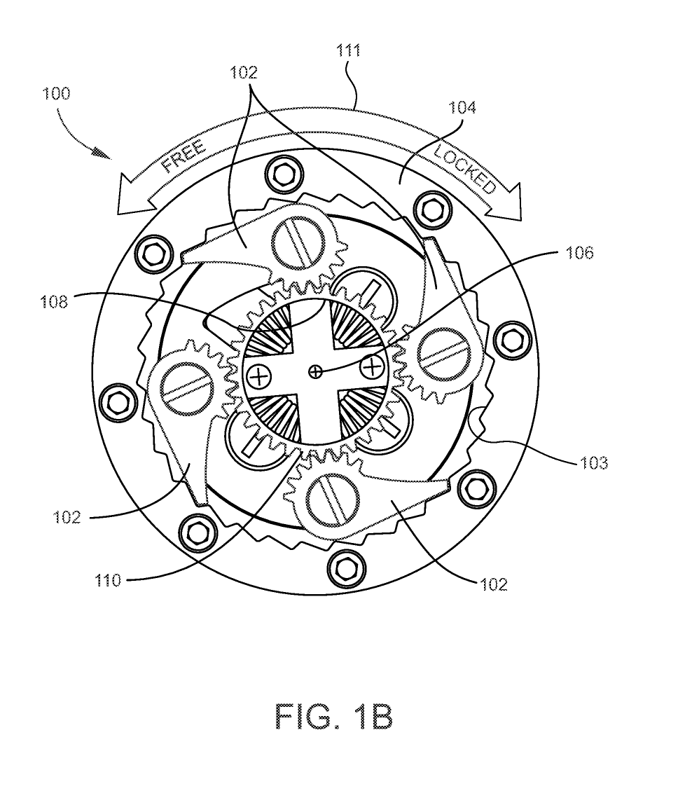

FIGS. 1A and 1B illustrate front views of a unidirectional, rotary clutch system 100 having an electromechanical control in different modes for alternately engaging and disengaging an output member in accordance with embodiments of the present subject matter. Referring initially to FIG. 1A, this figure shows the system 100 in a mode in which multiple pawls 102 are positioned such that the pawls do not engage an interior interference surface (i.e., ratchet) 103 of an output member 104. In this mode, the output member 104 can move freely in either rotational direction about an axis 106 of an input member 108. The double sided arrow 109 in the figure shows the rotational direction of the output member 104 about the axis 106.

Now turning to FIG. 1B, this figure shows the system 100 in another mode in which the pawls 102 are positioned to engage the interior interference surface 103 of the output member 104. In this mode, the output member 104 can move freely in one rotational direction as depicted by the double sided arrow 111 shown in the figure. Although, the pawls 102 lock or prevent the output member 104 from moving in the other rotational direction as depicted by the double side arrow 111 shown in the figure. The interior surface 103 of the output member 104 defines multiple ratchet faces for causing interference with the pawls 102 when the pawls 102 are engaged with the interior surface 103.

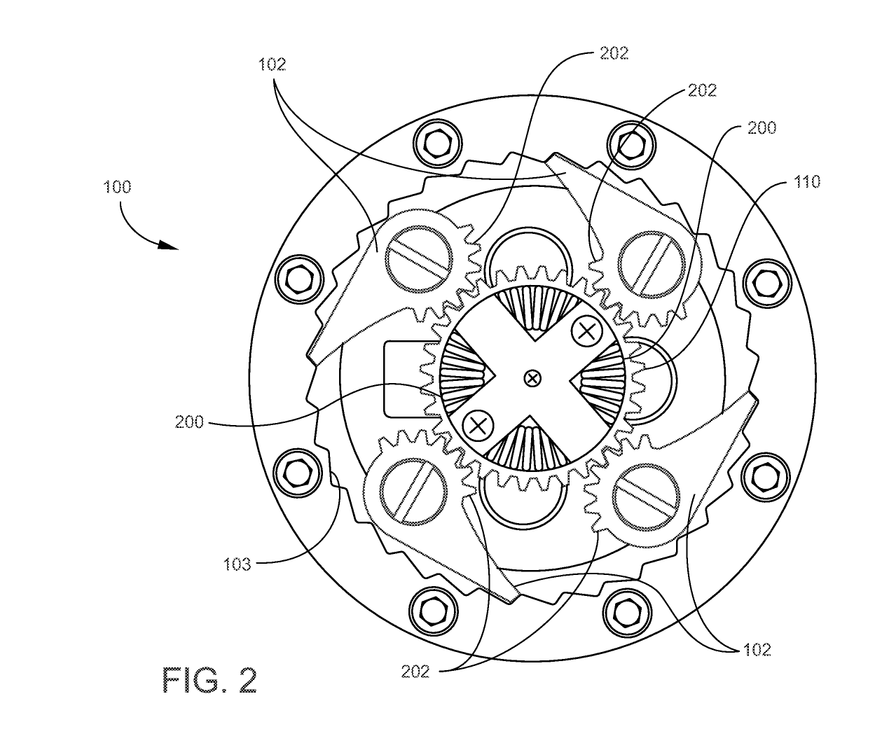

FIG. 2 illustrates a front view of additional details of the clutch system 100 shown in FIGS. 1A and 1B. Referring to FIG. 2, to engage, a unidirectional setting on an electromechanical motor or any other suitable mechanism (not shown) can turn a compliant gear 110, which is coupled to the pawls 102, which in turn can engage the interior surface 103 for allowing only unidirectional rotation of the clutch. The electromechanical motor does not hold any of the force (F) transmitted by the clutch as these forces are transmitted from the ratchet to the pawl if locked. This can couple the inner and outer components of the bearing when locked for transmitting torque (τ).

To disengage the device, the electromechanical motor can turn in the opposite direction, to thereby drive the compliant gear 110 to retract the pawls 102 and allow free rotation in both directions indicated by arrow 109 shown in FIG. 1A. It is noted that the electromechanical motor does not directly drive the compliant gear 110 in this example but is attached to the compliant gear 110 by internal compression springs, which may be interchanged with other compliant materials or springs 200, providing spring force torque to the pawls 102 which allow the ratcheting mechanism to turn in one direction and lock in the other direction as indicated by arrow 111 shown in FIG. 1B. Alternatively the motor may be driven in a way that it functions like the compliant gear with enough torque applied to the ratchet surface to allow the pawl to ratchet in one direction without restricting ratcheting.

The pawls 102 may be engaged to the surface of the ratchet by torque applied by the compliant gear 110. The gear 110 can be compliantly driven by the electromechanical or servo motor through a servo mounted adapter which can be attached to the gear's compression springs 200.

In accordance with embodiments of the present subject matter, torque can be applied directly to the compliant gear 110 in a counter-clockwise direction. The compliant gear 110 is not, in this example, directly coupled to the electromechanical motor. Further, the compliant gear 110 may have loose clearance on its center hole. The compression springs 200 may apply torque to the gear 110 when turned by the electromagnetic motor in the clockwise direction.

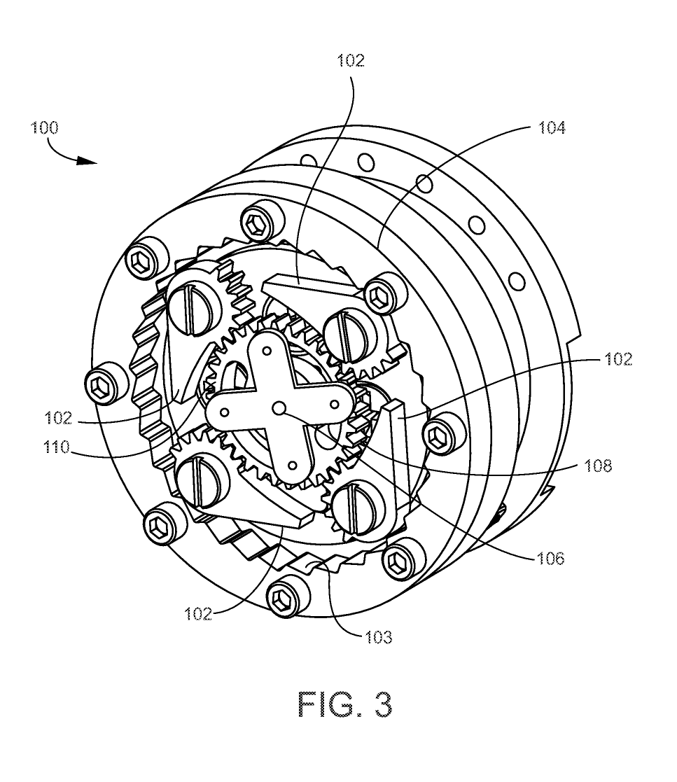

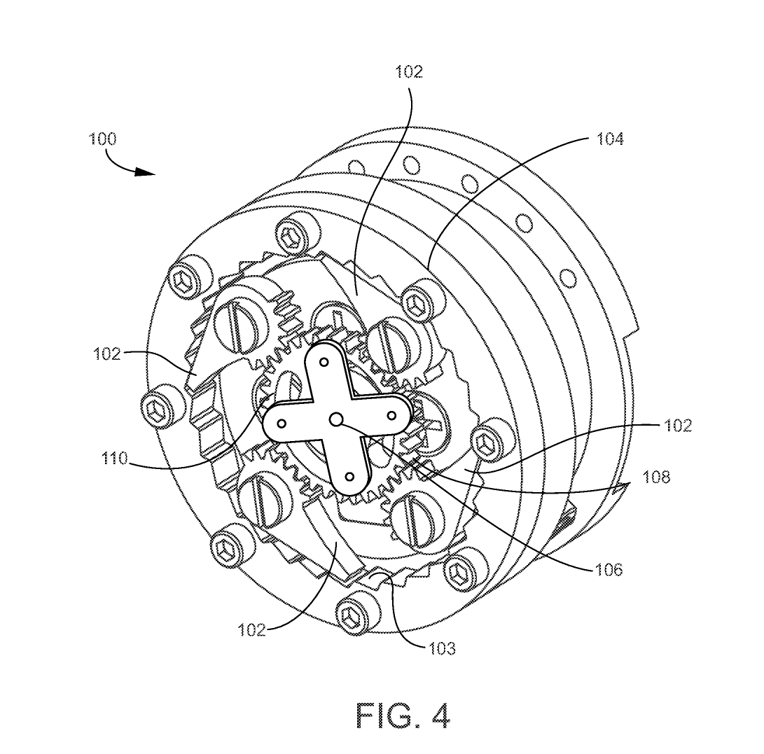

FIGS. 3 and 4 illustrate perspective views of the clutch system 100 shown in FIG. 1 in different modes for disengaging and engaging, respectively, the output member 104 in accordance with embodiments of the present subject matter.

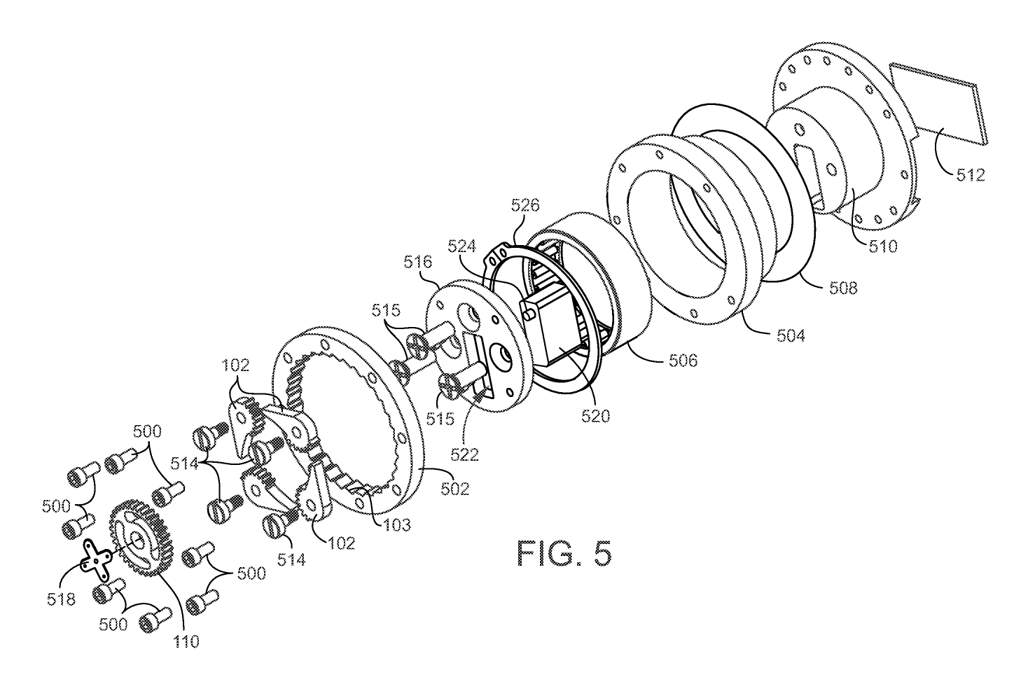

FIG. 5 illustrates a perspective, exploded view of the clutch system 100 in accordance with embodiments of the present subject matter. Referring to FIG. 5, the system 100 may include multiple fasteners 500 for attaching the ratchet 502 and an outer attachment bracket 504 of the output member 104. The ratchet 502 includes the interference surface 103 for engaging the pawls 102. The bracket 504 may be an exterior component of the clutch were wires, cables, or solid members can be mounted. The system includes a bearing 506 that is configured to permit the clutch to rotate with low friction. A low-friction washer 508 can be suitably positioned between the bracket 504 and a mounting component 510 for reducing friction between the bracket 504 and the mounting component 510. The mounting component 510 can define a surface for the clutch to rest against. Further, the mounting component 510 can house an electromechanical motor 520 and driving circuitry 512.

With continuing reference to FIG. 5, the system 100 includes multiple fasteners 514 for attaching the pawls 102 to component 502. Fasteners 515 can attach component 516 to component 510.

The system 100 includes a motor output shaft 518 that is attached to the compliant gear 110, which may be attached to an electromechanical motor 520. The electromechanical motor 520 can fit within a notch 522 of the component 514 for holding the electromechanical motor 520 in place. The electromechanical motor 520 can rotate a component 524 about the axis 106 for turning the compliant gear 110 as described herein.

The pawls 102 are geared pawls in this example. The geared portion 202 of the pawls 102 can engaged the compliant gear 110.

In an example, the system 100 may include a snap ring 526. In other example, the snap ring 526 is not utilized.

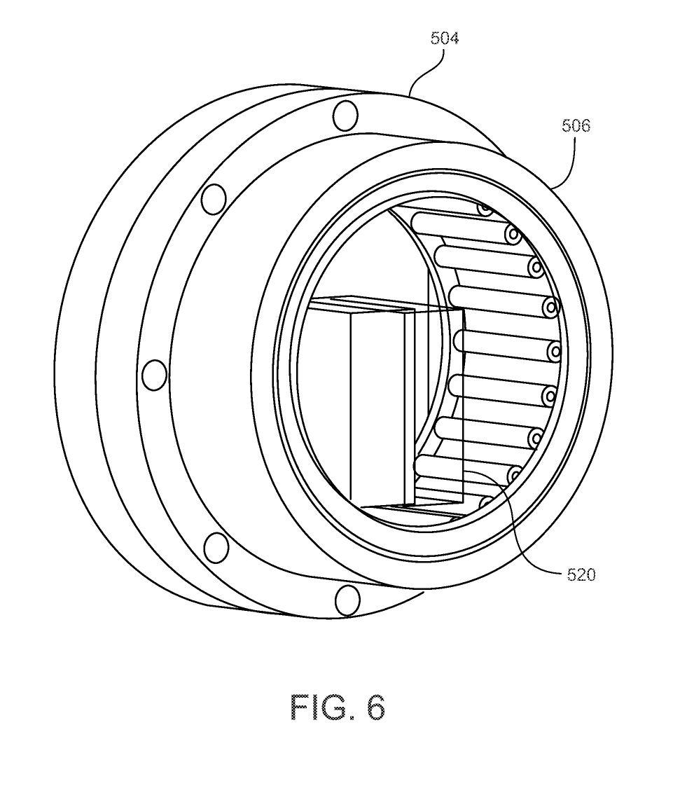

FIG. 6 illustrates a sectioned view of the bracket 504 and the bearing 506 in accordance with embodiments of the present subject matter. Referring to FIG. 6, the bracket 504 can provide bearing support for the output member of an electromechanical control of the clutch system 100 in accordance with embodiments of the present subject matter. The motor 520 may be positioned inside a stationary clutch attachment and may support loads transmitted by the outer clutch through the bearing 506.

In accordance with embodiments of the present subject matter, an electromechanical motor or other mechanism as disclosed herein may be operably controlled by a microcontroller configured to control the angle of a servo motor to either engage or disengage the clutch based off of either sensor or an input signal.

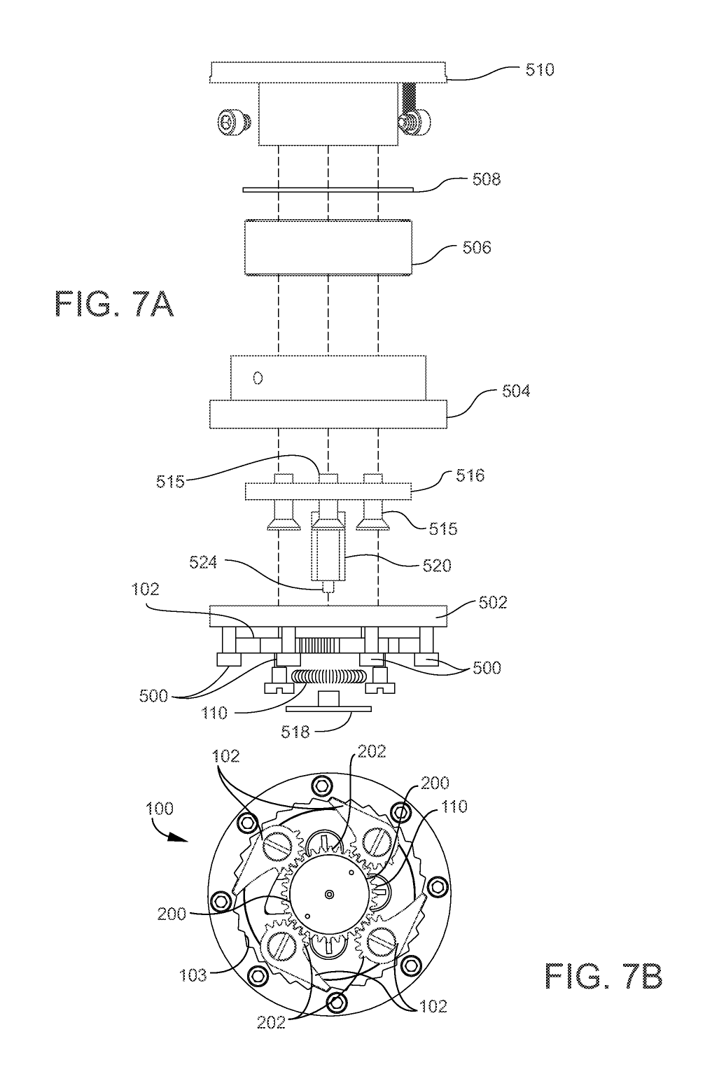

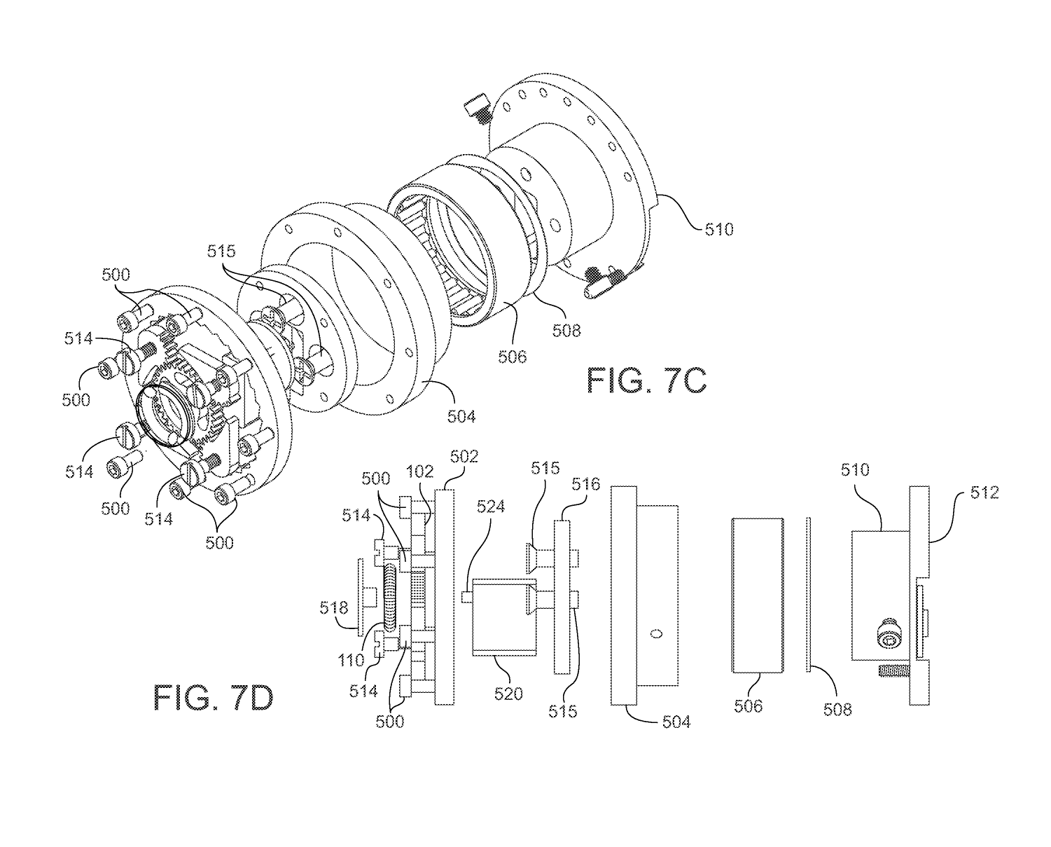

FIGS. 7A-7D depict different views of another example clutch system 100 in accordance with embodiments of the present subject matter. Particularly, FIG. 7A depicts an exploded, top view of the system 100, FIG. 7B depicts a front view of the system 100, FIG. 7C depicts an exploded, perspective view of the system 100, and FIG. 7D depicts an exploded, side view of the system 100. [

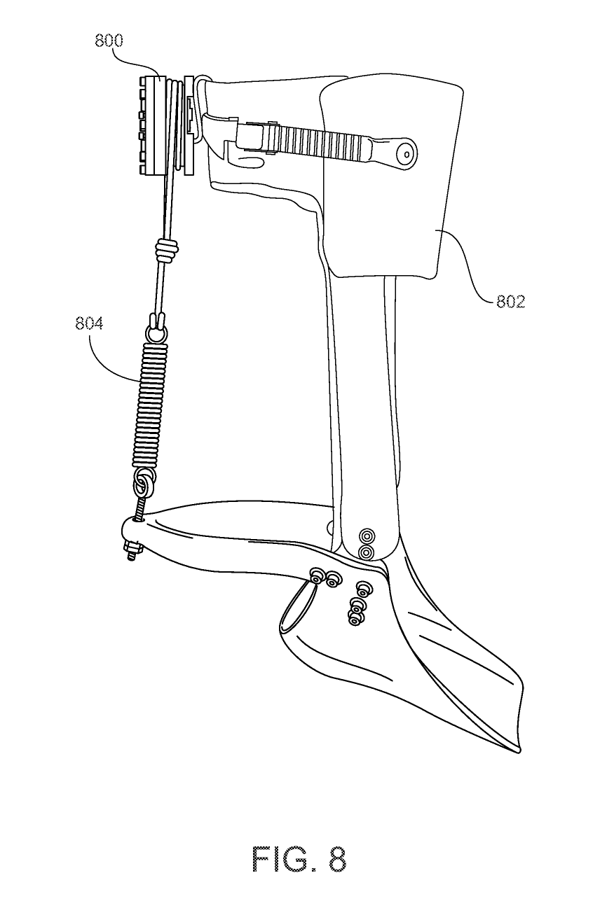

FIG. 8 illustrates a side view of a clutch system 800 attached to an exoskeleton 802 for a person's leg in accordance with embodiments of the present subject matter. Referring to FIG. 8, the exoskeleton 802 can be fitted to a person's foot and lower portion of the leg. The system 800 is positioned on the exoskeleton 802 near placement of the person's calf in the exoskeleton 802. Further, a spring 804 can be connected between the system 800 and a portion of the exoskeleton 802 that is fitted to a rear portion of the foot. The spring 804 can be controlled to store energy and return energy for assisting the person with walking. Using only power required to engage a pawl onto a ratcheting mechanism via a small servo motor, the clutch system 800 can allow for the transfer of energy from rotary motion of the ankle into and out of the spring 804 with precise timing based on biological feedback signals (e.g., ground contact events, joint angle threshold, and/or muscle activity threshold).

As will be appreciated by one skilled in the art, aspects of the present subject matter may be embodied as a system, method or computer program product. Accordingly, aspects of the present subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer or portable device through any type of network, including, Bluetooth, a local area network (LAN) or a wide area network (WAN), or the connection may be made to an external computer (for example, through the Internet using an Internet Service Provider).

The terminology used herein is for the purpose of describing particular embodiments only and is not intended to be limiting of the subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present subject matter has been presented for purposes of illustration and description, but is not intended to be exhaustive or limited to the present subject matter in the form disclosed. Many modifications and variations will be apparent to those of ordinary skill in the art without departing from the scope and spirit of the present subject matter. The embodiment was chosen and described in order to best explain the principles of the present subject matter and the practical application, and to enable others of ordinary skill in the art to understand the present subject matter for various embodiments with various modifications as are suited to the particular use contemplated.

The descriptions of the various embodiments of the present subject matter have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A clutch system comprising:
an input member having an axis of rotation;
an output member defining an interference surface;
a plurality of pawls attached to the input member and each being configured to be positioned in a first position to engage the interference surface of the output member, and to be positioned in a second position such that the pawls do not engage the interference surface of the output member; and
an electromechanical control configured to move the pawls between the first and second positions for alternately engaging and disengaging the interference surface of the input member.

2. The clutch system of claim 1, wherein the interference surface of the output defines a plurality of ridges for engaging the pawls when positioned in the first position.

3. The clutch system of claim 1, wherein a ratcheting mechanism is formed in the first position such that the output member is capable of at least substantially freely rotating about the axis with respect to the input member in a first direction, and such that the output member is at least substantially prevented from rotating about the axis with respect to the input member in a second direction that opposes the first direction.

4. The clutch system of claim 3, wherein the ratcheting mechanism further comprises a gear mechanism including a gear having at least one internal compression spring.

5. The clutch system of claim 1, wherein, in the second position, the output member is capable of rotating about the axis with respect to the input member in a first direction and a second direction that opposes the first direction.

6. The clutch system of claim 1, further comprising a mechanism capable of moving the pawls between the first and second positions.

7. The clutch system of claim 6, wherein the mechanism rotates the pawls to move the pawls between the first and second positions.

8. The clutch system of claim 6, wherein the electromechanical control is configured to controllable the mechanism to move the pawls between the first and second positions.

9. The clutch system of claim 1, wherein the interference surface comprises one of an exterior surface of the output member or an interior surface of the output member that faces the axis.

10. A method comprising:
providing a clutch system comprising:
an input member having an axis of rotation;
an output member defining an interference surface that faces the axis; and
a plurality of pawls attached to the input member and each being configured to be positioned in a first position to engage the interference surface of the output member, and to be positioned in a second position such that the pawls do not engage the interference surface of the output member; and
moving the pawls between the first and second positions for engaging and disengaging the interference surface of the input member.

11. The method of claim 10, wherein the interference surface of the output defines a plurality of ridges for engaging the pawls when positioned in the first position.

12. The method of claim 10, wherein providing a ratcheting mechanism in the first position such that the output member is capable of at least substantially freely rotating about the axis with respect to the input member in a first direction, and such that the output member is at least substantially prevented from rotating about the axis with respect to the input member in a second direction that opposes the first direction.

13. The method of claim 12, wherein the ratcheting mechanism further comprises a gear mechanism including a gear having at least one internal compression spring.

14. The method of claim 10, wherein, in the second position, the output member is capable of rotating about the axis with respect to the input member in a first direction and a second direction that opposes the first direction.

15. The method of claim 10, further comprising providing a mechanism capable of moving the pawls between the first and second positions.

16. The method of claim 15, further comprising rotating the pawls to move the pawls between the first and second positions.

17. The method of claim 15, further comprising electromechanically controlling the mechanism to move the pawls between the first and second positions.

18. The method of claim 12 wherein the interference surface comprises one of an exterior surface of the output member or an interior surface of the output member that faces the axis.
